(19) United States
(12) Patent Application Publication
(10) Pub. No.: US 2006/0075427 A1
(43) Pub. Date: Apr. 6, 2006

(54) Methods, apparatus, and computer program products for recording media files

(76) Inventors: Robert Koch, Norcross, GA (US); Dale Malik, Atlanta, GA (US)

Correspondence Address: CANTOR COLBURN LLP - BELLSOUTH, 55 GRIFFIN ROAD SOUTH, BLOOMFIELD, CT, 06002, US

(21) Appl. No.: 11/254,316

(22) Filed: Oct. 20, 2005

Related U.S. Application Data
(63) Continuation-in-part of application No. 10/958,813, filed on Oct. 5, 2004.

(51) Int. Cl. H04N 7/10; H04N 5/445; G06F 13/00

(52) U.S. Cl. 725/34; 725/42; 725/89

(57) ABSTRACT

An apparatus for recording media files from a portable storage medium, includes a content receiver for receiving a broadcast and a content identifier, the content identifier associated with the broadcast. The apparatus also includes a content storage/player in communication with the content receiver, the content storage/player operable for selecting the content identifier from the content receiver and initiating a request for an activity via the content identifier, the content identifier being mapped to the activity. Wherein the content storage/player includes an intelligent device for reading media files from the portable storage medium and a digital recording device that is capable of recording media files to a storage device.

### CROSS-REFERENCE TO RELATED APPLICATIONS

This application is a continuation-in-part application of U.S. non-provisional application Ser. No. 10/958,813, the contents of which are incorporated by reference herein, filed Oct. 5, 2004.

### BACKGROUND

Embodiments of the invention relate generally to communications systems, and more particularly, to methods, systems, and computer program products for implementing interactive content-based activities over a network.

Continuous advancements made with respect to technologies associated with the electronics industry have resulted in significant improvements in various product features of electronics devices such as personal and desktop computers, DVD players, and stereo systems, to name a few. For example, computer manufacturers now offer increased memory capacity, faster processors, longer battery life, etc. At the same time, electronics manufacturers are continuously striving to reduce the overall size of many of these devices, without sacrificing any of these improved features, in order to satisfy the demand for portability. As with standard or traditional electronics devices, portable electronics devices such as digital music players, personal digital assistants (PDAs) or ‘pocket PCs’, and the like are becoming increasing popular. Accordingly, electronics manufacturers and various service providers are constantly searching for new ways to provide value to the consumers of these devices in order to gain and maintain a competitive edge over their industry counterparts.

Another area that is experiencing growth in technology is the broadcast industry. The development of new standards in broadcast communications have enabled broadcast enterprises to deliver a variety of information, both related and unrelated to a broadcast, along with the actual broadcast content (e.g., music, audio/video programming, news, etc.). As long as the broadcast-receiving device is enabled with the standard, it can receive, translate, and respond to the delivered information. For example, a display on the receiving device (e.g., car stereo) may present information relating to content (such as a song) that is currently being broadcast such as a station identification of the broadcasting station, the artist name, and the title of the song, to name a few. Additionally, information unrelated to the content being broadcast (such as advertising) may be delivered and presented. While having this additional information may be useful, the technology does not currently support interactive communications between a broadcast recipient and the sources related to the content broadcast. For example, in response to hearing a song broadcast on a recipient's receiving device, the recipient may desire to contact a source to purchase the song (e.g., via download or placing an order with a music provider) at the time of the broadcast or shortly thereafter.

It is desirable, therefore, to provide a means for enabling interactive communications between a recipient of a broadcast and a content provider or a source related to the broadcast content.

### SUMMARY

Exemplary embodiments include an apparatus for recording media files from a portable storage medium including: a content receiver for receiving a broadcast and a content identifier, the content identifier associated with the broadcast; a content storage/player in communication with the content receiver, the content storage/player operable for selecting the content identifier from the content receiver and initiating a request for an activity via the content identifier, the content identifier being mapped to the activity; and wherein the content storage/player comprises an intelligent device that is capable of reading media files from the portable storage medium and a digital recording device that is capable of recording media files to a storage device.

Embodiments also include a method for recording media files from a portable storage media while playing the media file including: selecting a media file to be stored to a storage device; selecting a media file type to the storage device with an intelligent device; converting the media file into the selected media file type; and storing the media file in the selected media file type on a storage device.

Other systems, methods, and/or computer program products according to exemplary embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring now to the drawings wherein like elements are numbered alike in the several FIGURES:

FIG. 1 is a block diagram of a system upon which interactive content-based activities may be implemented in exemplary embodiments;

FIG. 2 is a block diagram of a content receiver and its components in exemplary embodiments;

FIG. 3 is a block diagram of a content storage/player and its components in exemplary embodiments;

FIG. 4 is a flow diagram of a process for implementing the interactive content-based activities in exemplary embodiments; and

FIG. 5 is a block diagram of a content storage/player and its components in alternate embodiments.

### DETAILED DESCRIPTION

In accordance with exemplary embodiments, the interactive content-based activities system provides a means by which a recipient of broadcast content (also referred to herein as “broadcast”) may initiate a real-time request for an item, service, or information (collectively referred to herein as “activity”) that is associated with the broadcast content. Broadcast content may include music, audio/video programming, advertising, news, etc., that is transmitted via, e.g., over-the-air radio frequency (RF) signals, satellite technology, or digitally over a network, to name a few. A unique content identifier is assigned to each broadcast event or segment within a broadcast event and is transmitted together with the broadcast event. Using the content identifier, a recipient of the broadcast content may initiate a request for an activity that is related to the broadcast content. The request may be initiated during the broadcast or sometime after the broadcast has completed.

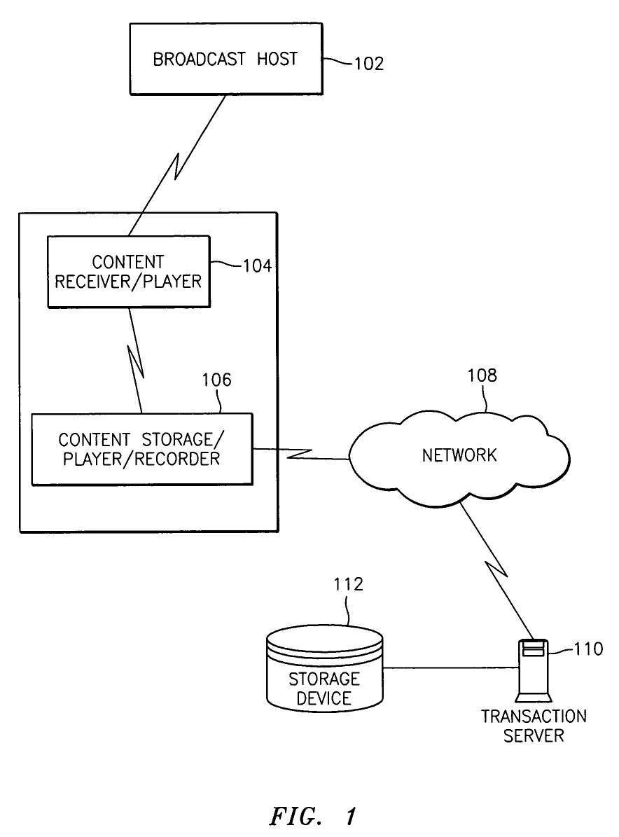

Referring now to FIG. 1, a block diagram of an exemplary system for implementing interactive content-based activities is generally shown. The exemplary system of FIG. 1 includes a broadcast host system 102 in communication with a content receiver 104. Broadcast host system 102 provides broadcast content (e.g., music, programming, sports, news, advertising, etc.) to content receiver 104 via a transmissions means such as over-the-air radio frequency (RF) signals or a digital network (e.g., broadband digital subscriber line (DSL)). In addition to transmitting content, broadcast host system 102 also transmits supplementary content information in the form of digital encoded signals. The supplementary content information may include for example, the identification of the broadcast host system, the artist/composer/owner of the content, the title of the content, a content identifier that distinguishes the content from other broadcast items, or other information related to the broadcast event. Broadcast host system 102 may be a radio station or Internet radio service provider that transmits audio content, a television or other audio/video content service provider, or other similar type of content provider system. Additionally, the content that is broadcast may comprise any type of media (e.g., video, images, text, etc.).

In accordance with one embodiment, broadcast host system 102 is a broadcast radio station that transmits content via radio frequency (RF) signals. Broadcast host system 102 provides Radio Data System (RDS), Radio Broadcast Data System (RBDS), or similar type of service to its customers. For example, in addition to transmitting traditional content (e.g., music, programming, advertisements), radio stations may transmit supplementary information associated with the broadcast content in the form of encoded digital signals that are received and analyzed by an RDS/RBDS-enabled receiver. RDS/RBDS technology enables a receiver to identify the radio station it is tuned into, offers the ability to pre-select programming types from available stations (e.g., music only content), a broadcast intercept feature that provides traffic advisory information, as well as other capabilities. The RDS and RBDS specifications have been adopted by official standardization bodies such as the European Center for Electrotechnical Standardization (CENELEC) in Europe, as well as the National Radio System Committee (NRSC) of the National Association of Broadcasters® (NAB) and the Electronic Industries Association (EIA) in the United States.

In exemplary embodiments, content receiver 104 receives broadcast signals (e.g., RF, data, satellite) from broadcast host system 102, translates the signals, and presents the resulting content to a broadcast recipient. Content receiver 104 may also receive audio content from other broadcast host systems (e.g., multiple radio stations) within its range. In one embodiment, content receiver 104 is a radio that is RDS/RBDS enabled. Alternatively, the radio described above with respect to the content receiver 104 may employ a global positioning system (GPS) device. In other embodiments, content receiver is an RDS/RBDS-enabled home stereo system that receives RF signals from broadcast host system 102. Content receiver 104 converts the signals to audio signals and presents the resulting audio content to a listener as well as the supplementary data facilitated by the RDS/RBDS services. In yet further embodiments, content receiver 104 may be a television or personal computer that receives broadcast content via a network, e.g., digital subscriber line (DSL) or cable services.

In exemplary embodiments, content storage/player 106 includes an intelligent device that stores and plays recorded or downloaded content. Content storage/player 106 may communicate with content receiver 104 via a Universal Serial Bus (USB) cable or via wireless technologies, e.g., Bluetooth™ or short messaging service (SMS) or other communication mechanism. Content storage/player 106 may also include input/output controls or options as well as a user interface for implementing the interactive content-based activities as will be described further herein. It will be understood that the form of user interface may vary from one type of content device to another (e.g., voice prompts and selections via key depressions may be used on a cellular telephone, web page user interface screen for a computer user, etc.); however, in exemplary embodiments the functionality of the user interface remains the same across all content storage/player devices.

Content storage/player 106 may be a portable device that includes digital recording and playback features such as those provided by, e.g., an iPod® player by Apple Computer, Inc® of Cupertino, Calif., or an iAUDIO M3® by Cowon Systems, Inc. of Seoul, Korea. In alternate embodiments, content storage/player 106 may be a web-enabled cellular telephone, personal digital assistant (PDA), a computer, an Internet-enabled television or other media device accessible via a network.

Content storage/player 106 may store a variety of content such as digital games, pictures, and personal data (e.g., calendars, organizers, etc.). Content storage/player 106 may play recorded music in an audio format such as Moving Picture Experts Group Audio Level 3 (MP3), Advanced Streaming Format (ASF), or WAV.

In yet further embodiments, content receiver 104 and content storage/player 106 comprise a single unit. For example, together content receiver 104 and content storage/player 106 may comprise a personal computer. The personal computer receives broadcast content, e.g., Internet radio over a network. The personal computer may include software for identifying participating Internet radio stations and receive broadcast content in the form of distributed streaming audio. The computer may comprise a desktop, laptop, or other similar general-purpose computing device known in the art. The computer may include memory (e.g., removable storage media, hard disk drive) for storing information such as files, documents, images, audio, applications, and multimedia.

Turning now to FIG. 5, a content storage/player 106 in exemplary embodiments is shown. The content storage/player 106 includes a storage device 500 and an intelligent device 502 that plays media content from a portable storage medium. The intelligent device 502 may include a CD player, a DVD player, or any other suitable device for playing media files. The intelligent device 502 further includes a digital recording device 504 suitable for storing media content onto the storage device 500. The intelligent device 502 is capable of simultaneously playing the media files and storing them to the storage device 500. Optionally, the intelligent device 502 converts the file type of the media file before storing the media file on the storage device 500.

In exemplary embodiments, the content storage/player 106 is a car stereo that is capable of playing a CD while recording the songs from the CD onto the storage device 500. Additionally, the car stereo could be configured to convert the CD tracks into a more compressed format such as MP3. The storage device 500 of content storage/player 106 may be a removable media such as a removable hard drive or portable media player such as an IPod™ or PSP™.

In exemplary embodiments, the content storage/player 106 is a portable entertainment system that is capable of playing a DVD while recording the video and/or audio from the DVD onto the storage device 500. The portable entertainment system may also be configured to compress the audio and video files in various formats. The storage/player 106 may also include a communications port 506 such as an USB or Firewire port that can be used to transfer audio and video files to and from other devices to the storage device 500. In other exemplary embodiments the communications port 506 may be a wireless communication device, which may be, but is not limited to, an RF or IR communication device. The wireless communication device may also be used for transferring audio and video files to and from the storage device 500.

The content storage/player 106 may present the user with the option of storing all of the media files from the portable storage medium to the storage device 500. Alternatively, the content storage/player 106 may be designed to automatically store all of the media files from the portable storage medium to the storage device 500. Additionally, the content storage/player 106 may allow the user to select the type of file that the media file will be stored at and optionally the user can specify the quality of the file to be stored. For example, the user may be able to specify the sampling rate of the media file depending upon the available space in the storage device 500.

Also included in the exemplary system of FIG. 1 is a transaction server 110 and storage device 112. Transaction server 110 may communicate with content storage/player 106 via a network 108. Content storage/player 106 (or both of content receiver 104 and content storage/player 106 if they comprise a single unit) may communicate with transaction server 110 utilizing one or a combination of communications technologies including, e.g., satellite or cellular technology, wireless technologies, circuit-switched networking, and packet-switched networking, among others. In exemplary embodiments of the present invention, transaction server 110 operates as a database server and coordinates access to applications and data stored on the storage device 112.

The transaction server 110 depicted in the system of FIG. 1 may be implemented using one or more servers operating in response to a computer program stored in a storage medium accessible by the server 110. The transaction server 110 may operate as a network server (e.g., a web server) to communicate with requesting devices such as content storage/player 106. The transaction server 110 handles sending and receiving information to and from the content storage/player 106 and can perform associated tasks. The transaction server 110 may also include a firewall to prevent unauthorized access to the server and enforce any limitations on authorized access. For instance, an administrator may have access to the entire system and have authority to modify portions of the system. A firewall may be implemented using conventional hardware and/or software as is known in the art.

The transaction server 110 may also operate as an application server. The transaction server 110 executes one or more computer programs (i.e., an application for implementing the interactive content-based activities) to provide the functions described herein. Processing may be shared by the content storage/player 106 and the transaction server 110 by providing an application (e.g., java applet) to the content storage/player 106. Alternatively, the content storage/player 106 may include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions.

The storage device 112 includes data relating to broadcast content, supplementary information such as broadcast sources and content identifiers, as well as associated content and may be implemented using a variety of devices for storing electronic information. It is understood that the storage device 112 may be implemented using memory contained in the transaction server 110 or it may be a separate physical device. The storage device 112 is logically addressable as a consolidated data source across a distributed environment that includes network 108. Information stored in the storage device 112 may be retrieved and manipulated via the transaction server 110. Content identifiers are associated with specific broadcast content and are also mapped to specific activities. Supplementary information that is broadcast associated with the broadcast content may include an activity identifier. Activity identifies may indicate what type(s) of activities may be requested in response to the presentation of the broadcast content. Activities are executed in response to requests received via the corresponding activity identifiers. The following table illustrates sample content and supplemental information.

| Content_ID | CONTENT | ACTIVITY IDENTIFIER |
|---|---|---|
| MU1000893 | Song | Download Song file |
| MU1006199 | Advertisement | Purchase concert tix |
| MU6974448 | Station promotion | Enter Contest |

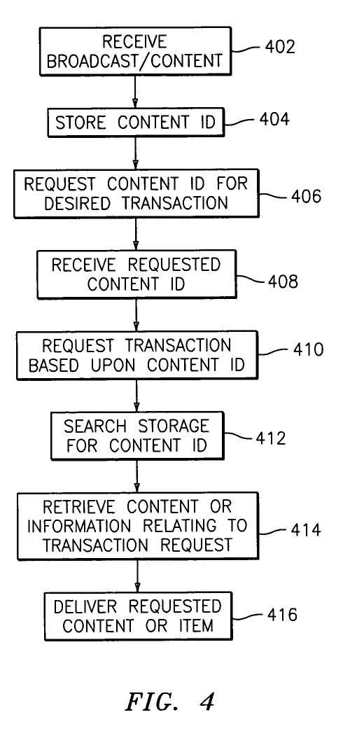

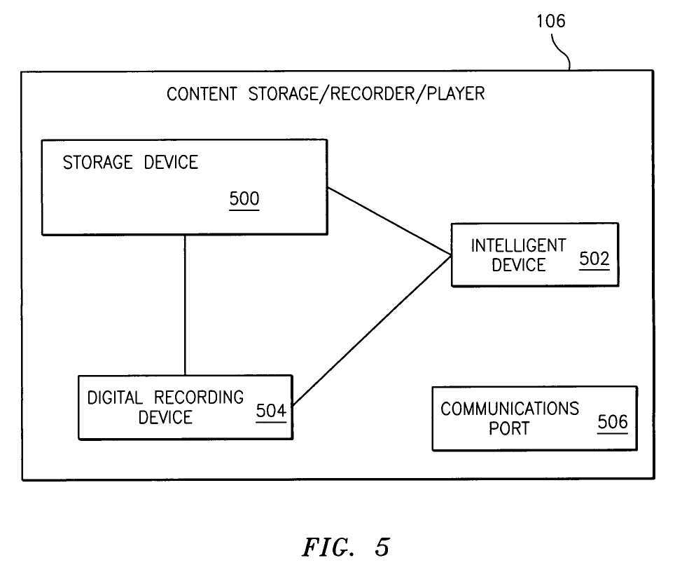

Referring to the example, a broadcast recipient hears a song that is received along with a corresponding content identifier “MU1000893” and activity identifier. The recipient transmits a request to server 110 that includes the content identifier and activity identifier. Exemplary Activity Identifies may include: Download Son, Purchase Item, Enter Contest, Vote, Request More Info, Go to Website, Call Now, and Show Map. The transaction server 110 then implements the request by enabling the recipient to download the song heard in the broadcast to the content storage/player 106. Details of this process are described further in FIG. 4.

As indicated above, the system of FIG. 1 also includes a network 108. The network 108 may be any type of known network including, but not limited to, a wide area network (WAN), a local area network (LAN), a global network (e.g. Internet), a virtual private network (VPN), and an intranet. The network 108 may be implemented using a wireless network or any kind of physical network implementation known in the art.

It will be understood that other types of content storage/players (e.g., digital cameras, personal video recorders, etc.) may also be utilized in implementing the interactive content-based activities. Accordingly, the content devices described above with respect to the system of FIG. 1 are provided for illustrative purposes and are not to be construed as limiting in scope.

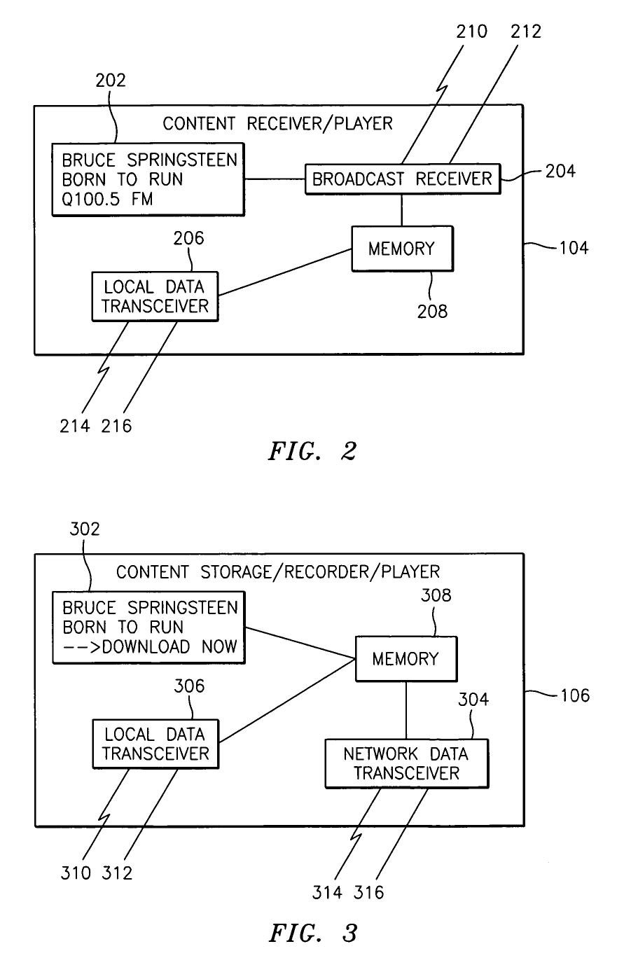

Turning now to the block diagram of FIG. 2, an exemplary content receiver and its components will now be described. Content receiver 104 includes a display means 202 for presenting information (including supplementary information) relating to a broadcast to a recipient. A broadcast receiver 204 receives and translates broadcast signals, including the supplementary data, that are transmitted using over-the-air RF signaling means 210 or may be data signals (e.g., data packets) that are transmitted using, e.g., a packet-switched network 212. Broadcast receiver 204 then sends the translated supplemental data to the display means 202. As shown in the diagram of FIG. 2, supplementary information presented in display means 202 includes an artist name, song title, and station identification. Optionally, the content identifier of the current broadcast event may be displayed.

The content identifier of a current broadcast, as well as the activity identifier and other supplementary information, may be stored in memory 204 residing within content receiver 104. Alternatively, a log of recently broadcast content identifiers, activity identifies, and other supplementary information may be stored in memory 208. Content receiver 104 also includes a local data transceiver 206 that communicates with content storage/player 106 via wireless means (e.g., short messaging service, Bluetooth™, etc.) 214 or may communicate with content storage/player 106 via wireline means (e.g., USB cable) 216.

An exemplary diagram of a content storage/player will now be described with respect to FIG. 3. Content storage/player 106 includes a display means 302, a memory 308, a local data transceiver 306, and a network data transceiver 304. As described above, content storage/player 106 may communicate with content receiver 104 via wireless means (e.g., short messaging service, Bluetooth™, etc.) 214 or may communicate with content receiver 104 via wireline means (e.g., USB cable) 216. This communication is facilitated by the local data transceiver 306 of content storage/player 106.

Memory 308 may store content in accordance with the type of content storage/player 106 being utilized (e.g., a digital music player storing audio content, a personal computer storing video, etc.). Memory 308 may also store an executable application for implementing the interactive content-based activities described herein. Memory 308 may communicate with display 302 when a recipient initiates a request via input controls on content storage/player 106. Network data transceiver 304 communicates with transaction server 110 over a wireless network 314 or wireline network 316 similar to those described above.

An exemplary process for implementing the interactive content-based activities will now be described with respect to FIG. 4. For purposes of illustration, the processes described with respect to FIG. 4 refer to broadcast content consisting of music and the requested activity refers to a request to download a song file. However, it will be understood by those skilled in the art that any type of broadcast content and/or activity may be applied to the processes described herein.

At step 402, a broadcast is received by content receiver 104 from broadcast host system 102. In addition to the subject content (e.g., song), the broadcast content also includes supplementary information (e.g., the identification of the broadcast host system, the artist/composer/owner of the content, the title of the content, an activity identifier, a content identifier that distinguishes the content from other broadcast items, associated advertising or other content, a WWW URL, or other associated content) via RDS/RBDS or other technologies. Content receiver 104 stores the content identifier at step 404 and may also store a log of recent broadcasts which includes one or more of the above associated supplemental information items.

When an individual is interested in an activity associated with a broadcast, the individual selects an option on the content storage/player 106 in order to execute the activity. Upon selecting the option, the content storage/player 106 initiates a communication session with the content receiver 104 via communications means 214 or 216, requesting the current activity identifier (if the broadcast is currently underway) or may optionally request the log from the memory 208 in content receiver 104. At step 408, the individual selects the desired activity identifier from the log that is shown in the display 302 of content storage/player 106.

An offer is presented to a user to request that an activity be executed, preferably via a visual or audible prompt. For example, a request option 310 “Download Now” is shown on display 302 for selection by a recipient. Upon selecting this option, the content storage/player 106 initiates a session over network 108 via communications means 314 or 316 and contacts transaction server 110 at step 410. Transaction server 110 performs a search of storage device 112 using the content identifier as a key at step 412. The activity or item mapped to the content identifier is retrieved at step 414. Transaction server 110 responds to the request in accordance with the requirements defined for the activity. By way of the example above, the recipient downloads the requested song.

As described above, the interactive content-based activities system provides a means by which a recipient of broadcast content may initiate a real-time request for an item, service, or information that is associated with the broadcast content. Broadcast content may include a variety of media types that are transmitted over a network. A unique content identifier that is assigned to each broadcast event is transmitted along with the broadcast event and is used by a recipient to initiate a request for an activity related to the broadcast content. The request may be initiated during the broadcast or for a defined period of time after the broadcast has completed.

As described above, embodiments may be in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

What is claimed is:

1. An apparatus for recording media files from a portable storage medium, comprising:
a content receiver for receiving a broadcast and a content identifier, the content identifier associated with the broadcast;
a content storage/player in communication with the content receiver, the content storage/player operable for selecting the content identifier from the content receiver and initiating a request for an activity via the content identifier, the content identifier being mapped to the activity; and
wherein the content storage/player comprises an intelligent device for reading media files from the portable storage medium and a digital recording device that is capable of recording media files to a storage device.

2. The apparatus of claim 1, wherein said content storage/player is a car stereo or other portable entertainment system.

3. The apparatus of claim 1, wherein said content storage/player includes a communications port for transferring media files to and from said storage device.

4. The apparatus of claim 2, wherein said content storage/player includes a communications port for transferring media files to and from said storage device.

5. The apparatus of claim 1, wherein the activity includes at least one of:
a content download including at least one of:
software;
document;
music file;
video file;
image; and
a multi-media item;
information relating to the broadcast;
a document;
a contest entry;
a product purchase; and
a service purchase.

6. The apparatus of claim 1, wherein the broadcast includes at least one of:
a video program;
an audio program;
music;
news;
sports;
advertisement;
promotion;
movie;
radio frequency broadcast; and
Internet radio broadcast.

7. A method for recording a media file from a portable storage media while playing the media file comprising:
selecting the media file to be stored to a storage device; and
storing the media file in the selected media file type on a storage device.

8. The method of claim 7, comprising:
selecting a media file type to the storage device with an intelligent device; and
converting the media file into the selected media file type.

9. The method of claim 7, comprising transferring the media file to an external device.

10. A computer program product for recording media files from a portable storage media while playing the media file, the computer program product comprising:
a storage medium readable by a processing circuit and storing instructions for execution by the processing circuit for facilitating a method comprising:
playing the media file;
selecting a media file to be stored to a storage device; and
storing the media file in the selected media file type on a storage device.

11. The computer program product of claim 10, wherein the method comprises:
selecting a media file type to the storage device with an intelligent device; and
converting the media file into the selected media file type.
The computer program product of claim 10, wherein the method comprises transferring the media file to an external device.
